(19) United States
(12) Patent Application Publication
(10) Pub. No.: US 2021/0061310 A1
(43) Pub. Date: Mar. 4, 2021

(54) INFORMATION PROCESSING APPARATUS, VEHICLE, INFORMATION PROCESSING SYSTEM, AND NON-TRANSITORY COMPUTER READABLE MEDIUM

(71) Applicant: TOYOTA JIDOSHA KABUSHIKI KAISHA, Toyota-shi (JP)

(72) Inventors: Ryuichi KAMAGA, Nisshin-shi (JP); Kouki MORIYA, Nagakute-shi (JP); Yui OGURA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/000,917

(22) Filed: Aug. 24, 2020

(30) Foreign Application Priority Data
Sep. 2, 2019 (JP) 2019-159916

(51) Int. Cl. B60W 60/00; G01C 21/34; G01C 21/36; G06Q 50/20; G06Q 10/06; G06Q 10/08; G06Q 30/02; G06Q 50/30; G06Q 30/06; G06F 16/25

(52) U.S. Cl. CPC B60W 60/0025; G01C 21/343; G01C 21/3605; G06Q 50/205; G06Q 10/06315; G09B 19/0092; G06Q 30/0282; G06Q 50/30; G06Q 30/0206; G06Q 30/0639; G06F 16/254; G06Q 10/087

(57) ABSTRACT

An information processing apparatus includes a controller. The controller acquires holding information on a cooking class to be held in a vehicle and provision information on an ingredient provider who provides an ingredient to be used in the cooking class. The controller executes matching between the cooking class and the ingredient provider based on the holding information and the provision information that are acquired, and determines ingredient procurement information to be notified to the ingredient provider, according to a result of the matching.

### CROSS-REFERENCE TO RELATED APPLICATION

This application claims priority to Japanese Patent Application No. 2019-159916, filed on Sep. 2, 2019, the entire contents of which are incorporated herein by reference.

### TECHNICAL FIELD

The present disclosure relates to an information processing apparatus, a vehicle, an information processing system, and a program.

### BACKGROUND

Cooking classes held among an instructor and a student at a predetermined date and time, and at a predetermined location equipped with cooking facilities and stocked with ingredients, are known. In such cooking classes, the instructor and the student gather at the predetermined date and time at the predetermined location, and then cooking instructions are given by the instructor to the student, using the ingredients with which the location is stocked. For example, ingredients used with the cooking instructions are provided by a predetermined ingredient provider.

Systems for providing a customer with a cooking service using, unlike the cooking class, a moving vehicle are known. For example, Patent Literature (PTL) 1 discloses an on-site cooking service system which is characterized by loading ingredients onto a vehicle equipped with cooking facilities, traveling to the customer's location, and cooking the ingredients brought in, using the cooking facilities in the vehicle, to provide a cooked dish at the customer's location.

### CITATION LIST

### Patent Literature

PTL 1: JP 2001-199274 A

### SUMMARY

In the conventional cooking class, the location and the date and time at which the class is held are predetermined to some extent, thus largely limiting the procurement location and the procurement date and time at which the ingredients are to be procured from the ingredient provider. Accordingly, even if the ingredient provider has a surplus of ingredients, a cooking class that can effectively utilize the ingredients may not be found at that point. As described above, the potential for matching between the cooking class and the ingredient provider is low, and thus the ingredients held by the ingredient provider have not been effectively provided to the cooking class.

In addition, in the on-site cooking service system disclosed in PTL 1, the vehicle equipped with the cooking facilities moves to the customer's location to thereby relax the limitations on the location and the date and time at which the cooking service is received. However, providing an ingredient from an ingredient provider to a cooking class to be held among an instructor and a student is not considered.

It would therefore be helpful to enable effective provision of an ingredient held by an ingredient provider to a cooking class.

An information processing apparatus according to an embodiment of the present disclosure includes a controller configured to:
acquire holding information on a cooking class to be held in a vehicle and provision information on an ingredient provider who provides an ingredient to be used in the cooking class;
execute matching between the cooking class and the ingredient provider based on the holding information and the provision information that are acquired; and
determine ingredient procurement information to be notified to the ingredient provider according to a result of the matching.

A program according to an embodiment of the present disclosure causes an information processing apparatus to execute:
acquiring holding information on a cooking class to be held in a vehicle;
acquiring provision information on an ingredient provider who provides an ingredient to be used in the cooking class;
executing matching between the cooking class and the ingredient provider based on the holding information and the provision information that are acquired; and
determining ingredient procurement information to be notified to the ingredient provider according to a result of the matching.

A program according to an embodiment of the present disclosure causes a terminal apparatus of an ingredient provider who provides an ingredient to be used in a cooking class, to execute:
transmitting provision information on the ingredient provider who provides the cooking class to be held in a vehicle with the ingredient, to an information processing apparatus; and
receiving ingredient procurement information determined by the information processing apparatus according to a result of matching between the cooking class and the ingredient provider executed by the information processing apparatus based on holding information on the cooking class and the provision information that are acquired by the information processing apparatus.

An information processing apparatus, a vehicle, an information processing system, and a program according to an embodiment of the present disclosure enables effective provision of an ingredient held by an ingredient provider to a cooking class.

### BRIEF DESCRIPTION OF THE DRAWINGS

In the accompanying drawings:

FIG. 1 is a configuration diagram illustrating a configuration of an information processing system including an information processing apparatus according to an embodiment of the present disclosure;

FIG. 2 is a functional block diagram illustrating a schematic configuration of each of an information processing apparatus, a first terminal apparatus, and a second terminal apparatus in FIG. 1;

FIG. 3 is a first diagram for explaining matching between a cooking class and an ingredient provider;

FIG. 4 is a second diagram for explaining matching between the cooking class and the ingredient provider;

FIG. 5 is a flowchart for explaining a first example of an information processing method executed by the information processing apparatus in FIG. 1;

FIG. 6 is a flowchart for explaining a second example of the information processing method executed by the information processing apparatus in FIG. 1;

FIG. 7 is a flowchart for explaining a third example of the information processing method executed by the information processing apparatus in FIG. 1; and

FIG. 8 is a flowchart for explaining a fourth example of the information processing method executed by the information processing apparatus in FIG. 1.

### DETAILED DESCRIPTION

An embodiment of the present disclosure will be described below, with reference to the drawings.

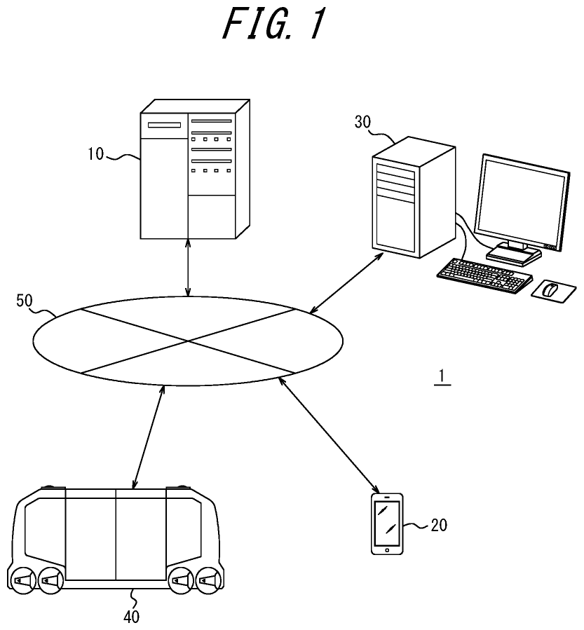

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. In addition to the information processing apparatus 10, the information processing system 1 includes a first terminal apparatus 20 and a second terminal apparatus 30. For the sake of simplicity, FIG. 1 illustrates one of each of the first terminal apparatus 20, the second terminal apparatus 30, and a vehicle 40, but the number of first terminal apparatuses 20 and second terminal apparatuses 30 included in the information processing system 1, and vehicles 40 may be two or more.

Each of the information processing apparatus 10, the first terminal apparatus 20, and the second terminal apparatus 30 is connected to a network 50 that includes, for example, a mobile communication network, the Internet, and the like, together with the vehicle 40, in which a cooking class is held, so as to communicate with each other. At least part of the information processing system 1 is used for providing a mobility service. Each service provider can provide a mobility service such as a mobile cooking class, by using the vehicle 40.

The information processing apparatus 10 is a single server apparatus or a plurality of server apparatuses that can communicate with each other. The information processing apparatus 10 is not limited to these, and may be any general purpose electronic device such as a personal computer (PC) or a smartphone, or may be any other electronic device that is dedicated to the information processing system 1.

The first terminal apparatus 20 is, for example, a general purpose electronic device such as a smartphone or a PC. The first terminal apparatus 20 is, for example, an electronic device used by an ingredient provider who provides the cooking class to be held in the vehicle 40 with an ingredient. The first terminal apparatus 20 is not limited to these, and may be an electronic device that is dedicated to the information processing system 1. In this specification, the “ingredient provider” includes, for example, an individual or an organization engaged in agriculture, an individual or an organization engaged in livestock breeding, an individual or an organization engaged in fishery, or a retailer running a supermarket, a convenience store, or the like. The number of ingredient providers may be one, or may be two or more.

The second terminal apparatus 30 is, for example, a general purpose electronic device such as a PC or a smartphone. The second terminal apparatus 30 is, for example, an electronic device used by a member of staff of an operating company that operates the cooking class to be held in the vehicle 40. The second terminal apparatus 30 is not limited to these, and may be a single server apparatus used by the operating company, or a plurality of server apparatuses used by the operating company that can communicate with each other, or may be an electronic device that is dedicated to the information processing system 1.

The vehicle 40 is, for example, an automobile. The vehicle 40 is not limited to this, and may be any vehicle that a person can board to hold the cooking class in the vehicle 40. While the cooking class is held, the vehicle 40 may move, or may be stationary. The vehicle 40 is, for example, a vehicle that performs automated driving. The automated driving may include any level from Level 1 to Level 5 as defined by the Society of Automotive Engineers (SAE), for example, but is not limited to these, and may be defined in any way. The vehicle 40 is not limited to a vehicle that performs automated driving, and may be any vehicle driven by a driver.

The vehicle 40 procures ingredients to be used in the cooking class from one or more ingredient providers. For example, the vehicle 40 that is the same as the vehicle 40 in which a cooking class is to be held directly procures an ingredient to be used in the cooking class from an ingredient provider. Without being limited to this, one or more vehicles 40 that are different from the vehicle 40 in which the cooking class is to be held may indirectly procure ingredients to be used in the cooking class from an ingredient provider, and deliver the ingredients to the vehicle 40 in which the cooking class is to be held. A corresponding type of the ingredient to be procured by each vehicle 40 may be previously determined, or the vehicle 40 that is closest to the ingredient provider among vehicles 40 that are dispersed in respective areas may procure the ingredients from the ingredient provider.

As an outline of an embodiment, the information processing apparatus 10 acquires holding information on each cooking class to be held in the vehicle 40. In this specification, the “holding information” includes various information related to holding of a cooking class in the vehicle 40. The “holding information” includes, for example, a holding area, a start date and time, an end date and time, a food and/or a beverage to be the theme, and a required ingredient. The “ingredient” information includes, for example, the type, the quality, and the amount of an ingredient.

The information processing apparatus 10 acquires provision information on each ingredient provider who provides an ingredient to be used in a corresponding cooking class. In this specification, the “provision information” includes various information related to provision, by an ingredient provider, of an ingredient to a cooking class to be held in the vehicle 40. The “provision information” includes, for example, a provision location and a provision date and time that are desired by an ingredient provider, and an ingredient that the ingredient provider desires to provide.

The information processing apparatus 10 executes matching between a cooking class and an ingredient provider based on the holding information and the provision information that are acquired, and determines ingredient procurement information to be notified to the ingredient provider according to the result of the matching. In this specification, “matching” means determining a certain cooking class and a certain ingredient provider for which the holding information and the provision information conform to each other, from a plurality of cooking classes and a plurality of ingredient providers, respectively. The “ingredient procurement information” includes various information required for the vehicle 40 to procure an ingredient to be used in a cooking class from an ingredient provider. The “ingredient procurement information” includes, for example, a procurement location, a procurement date and time, and an ingredient, regarding procurement of an ingredient.

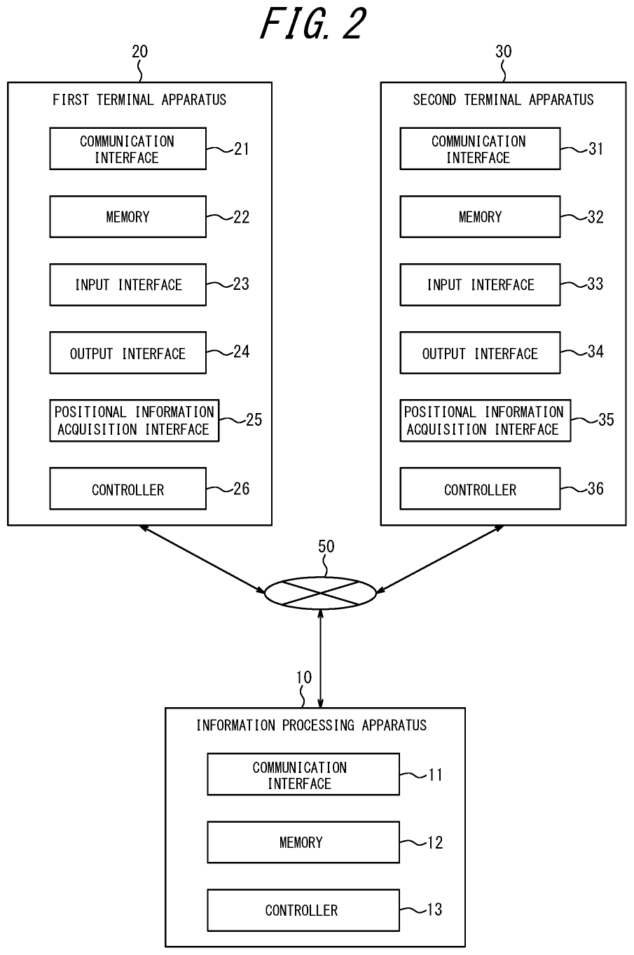

Next, referring to FIG. 2, a configuration of each apparatus included in the information processing system 1 will be primarily described. FIG. 2 is a functional block diagram illustrating a schematic configuration of each of the information processing apparatus 10, the first terminal apparatus 20, and the second terminal apparatus 30 in FIG. 1.

As illustrated in FIG. 2, the first terminal apparatus 20 includes a communication interface 21, a memory 22, an input interface 23, an output interface 24, a positional information acquisition interface 25, and a controller 26.

The communication interface 21 includes a communication module connected to the network 50. For example, the communication interface 21 may include a communication module compliant with mobile communication standards such as the 4th generation (4G) and the 5th generation (5G) standards. In an embodiment, the first terminal apparatus 20 is connected to the network 50 via the communication interface 21. The communication interface 21 transmits and receives various information via the network 50.

The memory 22 is, for example, a semi-conductor memory, a magnetic memory, an optical memory, or the like, but is not limited to these. The memory 22 may function as, for example, a main memory, an auxiliary memory, or a cache memory. The memory 22 stores any information used in operation of the first terminal apparatus 20. For example, the memory 22 may store a system program, an application program, various types of information received by the communication interface 21, and the like. Information stored in the memory 22 may be updated with, for example, information received from the network 50 via the communication interface 21.

The input interface 23 includes at least one input interface for detecting user input to acquire input information based on an operation by a user. The input interface 23 is, for example, a physical key, a capacitive key, a touch screen integrally provided with a display of the output interface 24, a microphone for receiving audio input, or the like, but is not limited to these.

The output interface 24 includes at least one output interface for outputting information to notify information to the user. The output interface 24 is, for example, a display for outputting the information in the form of an image, a speaker for outputting the information in the form of audio, or the like, but is not limited to these.

The positional information acquisition interface 25 includes at least one receiver compliant with a satellite positioning system. For example, the positional information acquisition interface 25 may include a Global Positioning System (GPS) receiver. The positional information acquisition interface 25 acquires a measured value of the position of the first terminal apparatus 20 as positional information. The positional information includes, for example, an address, a latitude, a longitude, and an altitude. The positional information acquisition interface 25 may continuously acquire, or may periodically or non-periodically acquire the positional information for the first terminal apparatus 20.

The controller 26 includes at least one processor. The “processor” is a general purpose processor or a dedicated processor that is dedicated to specific processing in an embodiment but is not limited to these. The controller 26 is connected to each component included in the first terminal apparatus 20 so as to communicate with each component, and controls operation of the entire first terminal apparatus 20.

When the input interface 23 detects an operation by the user as an ingredient provider who requests registration of provision information, the controller 26 displays an input screen indicating items required for registration of the provision information, using the output interface 24. The items required for registration of the provision information include, for example, items of a provision location and a provision date and time that are desired by the ingredient provider, and an ingredient that the ingredient provider desires to provide. The controller 26 acquires input information regarding these items that the user inputs by operating the input interface 23. The controller 26 transmits the acquired input information as the provision information to the information processing apparatus 10 via the communication interface 21 and the network 50.

The controller 26 receives, from the information processing apparatus 10 via the network 50 and the communication interface 21, ingredient procurement information according to a result of the matching between a cooking class and an ingredient provider executed by the information processing apparatus 10. The ingredient provider understands the ingredient to be provided to the cooking class, the procurement location, and the procurement date and time, from the ingredient procurement information notified by the first terminal apparatus 20. The ingredient provider provides the vehicle 40, which is navigated to the notified procurement location, with a required ingredient at the procurement location at the notified procurement date and time.

For example, when the input interface 23 detects an operation by the user as an ingredient provider who requests an evaluation of an instructor or a student in a cooking class, the controller 26 displays an input screen indicating items required for the evaluation of the instructor or the student, using the output interface 24. The items required for the evaluation include, for example, items of an evaluation target selected from among the instructor and the student, an evaluation index such as a rank and a score for the selected evaluation target, and an evaluation comment on the evaluation target. The controller 26 acquires input information regarding these items that the user inputs by operating the input interface 23. The controller 26 transmits the acquired input information as instructor evaluation information or student evaluation information indicating the result of the evaluation by the ingredient provider of another from among the instructor and the student of the cooking class and the ingredient provider, to the information processing apparatus 10 via the communication interface 21 and the network 50.

In this specification, the “evaluation information” includes, for example, an evaluation target, an evaluation index such as a rank and a score of the evaluation target, and an evaluation comment on the evaluation target. The term “student evaluation information” means evaluation information indicating a result of an evaluation of a student of a cooking class by an instructor of the cooking class or an ingredient provider. For example, “student evaluation information” means evaluation information indicating a result of an evaluation of a student of a cooking class by an instructor of the cooking class regarding cooking in the cooking class. For example, “student evaluation information” means evaluation information indicating a result of an evaluation, by an ingredient provider, of the quality of an evaluation comment received from a student after the ingredient provider checks the evaluation comment made by the student on the ingredient provider.

The term “instructor evaluation information” means evaluation information indicating a result of an evaluation of an instructor of a cooking class by a student of the cooking class or an ingredient provider. For example, “instructor evaluation information” means evaluation information indicating a result of an evaluation of an instructor of a cooking class by a student of the cooking class regarding cooking instructions in the cooking class. For example, “instructor evaluation information” means evaluation information indicating a result of an evaluation, by an ingredient provider, of the quality of an evaluation comment received from an instructor after the ingredient provider checks the evaluation comment made by the instructor on the ingredient provider.

The term “ingredient provider evaluation information” means evaluation information indicating a result of an evaluation of an ingredient provider by an instructor or a student of a cooking class. For example, “ingredient provider evaluation information” means evaluation information indicating a result of an evaluation of an ingredient provider, by an instructor or a student of a cooking class, regarding the quality of an ingredient provided by the ingredient provider to the cooking class.

The controller 26 receives ingredient provider evaluation information from the information processing apparatus 10 via the network 50 and the communication interface 21. When the input interface 23 detects an operation by the user of the ingredient provider, the controller 26 outputs the received evaluation information to the output interface 24.

Next, the configuration of the second terminal apparatus 30 included in the information processing system 1 will be primarily described. As illustrated in FIG. 2, the second terminal apparatus 30 includes a communication interface 31, a memory 32, an input interface 33, an output interface 34, a positional information acquisition interface 35, and a controller 36. With respect to the configuration of each component included in the second terminal apparatus 30, the same explanation as the corresponding component included in the above described first terminal apparatus 20 applies.

When the input interface 33 detects an operation by the user as a member of staff of an operating company who requests registration of holding information, the controller 36 displays an input screen indicating items required for registration of the holding information, using the output interface 34. The items required for registration of the holding information include, for example, items of a holding area, a start date and time, an end date and time, a food and/or a beverage to be the theme, and a required ingredient. The controller 36 acquires input information regarding these items that the member of staff inputs by operating the input interface 33. The controller 36 transmits the acquired input information as the holding information to the information processing apparatus 10 via the communication interface 31 and the network 50.

In addition to the holding information, the controller 36 also transmits participant information on participants including an instructor and a student participating in a cooking class, to the information processing apparatus 10 via the communication interface 31 and the network 50. In this specification, “participant information” includes, for example, an address of each participant, a participation start date and time, and a participation end date and time. The participant information is acquired by the controller 36 by, for example, being transmitted from any terminal apparatus used by the participants to the second terminal apparatus 30.

The controller 36 receives, from the information processing apparatus 10 via the network 50 and the communication interface 31, pickup information for the vehicle 40 to pick up the participants of the cooking class, which is determined by the information processing apparatus 10 based on the participant information. In this specification, “pickup information” includes, for example, a pickup location, a pickup route, and a pickup date and time that are optimized, according to the participant information, for the vehicle 40 to pick up the participants. The controller 36 notifies the participants of the pickup information received from the information processing apparatus 10, as required. For example, the participants understand the pickup location and the pickup date and time of the vehicle 40 in which the cooking class is held, based on the pickup information transmitted from the second terminal apparatus 30 to any terminal apparatus used by the participants.

The controller 36 receives, from a terminal apparatus used by an instructor, for example, student evaluation information regarding cooking in a cooking class, or ingredient provider evaluation information regarding the quality of an ingredient provided by an ingredient provider to the cooking class. The controller 36 transmits the received evaluation information as evaluation information indicating a result of an evaluation by the instructor of another from among the instructor and the student of the cooking class and the ingredient provider, to the information processing apparatus 10 via the communication interface 31 and the network 50.

The controller 36 receives, from a terminal apparatus used by a student, for example, instructor evaluation information regarding cooking instructions in a cooking class, or ingredient provider evaluation information regarding the quality of an ingredient provided by an ingredient provider to the cooking class. The controller 36 transmits the received evaluation information as evaluation information indicating a result of an evaluation by the student of another from among the instructor and the student of the cooking class and the ingredient provider, to the information processing apparatus 10 via the communication interface 31 and the network 50.

The controller 36 receives, from the information processing apparatus 10 via the network 50 and the communication interface 31, for example, instructor evaluation information indicating a result of an evaluation by an ingredient provider, of the quality of an evaluation comment received from an instructor. The controller 36 transmits the received evaluation information to a terminal apparatus used by the instructor, as required. For example, upon receiving instructor evaluation information indicating a result of an evaluation of the instructor by a student regarding cooking instructions in the cooking class, from a terminal apparatus used by the student, the controller 36 may transmit the received evaluation information to the terminal apparatus used by the instructor, as required.

The controller 36 receives, from the information processing apparatus 10 via the network 50 and the communication interface 31, for example, student evaluation information indicating a result of an evaluation by an ingredient provider, of the quality of an evaluation comment received from a student. The controller 36 transmits the received evaluation information to a terminal apparatus used by the student, as required. For example, upon receiving student evaluation information indicating a result of an evaluation of the student by an instructor regarding cooking in the cooking class, from a terminal apparatus used by the instructor, the controller 36 may transmit the received evaluation information to the terminal apparatus used by the student, as required.

In the vehicle 40, for example, vehicle control based on control information received from the information processing apparatus 10 is performed. The vehicle control is, for example, automated driving control for navigating the vehicle 40 to each pickup location, at which a corresponding participant is to be picked up, according to a pickup route based on the above mentioned pickup information determined by the information processing apparatus 10, but is not limited to this. The vehicle control may be automated driving control for navigating the vehicle 40 to a procurement location for procuring an ingredient to be used in a cooking class from an ingredient provider, based on procurement route information, which will be described later.

Next, the configuration of the information processing apparatus 10 included in the information processing system 1 will be primarily described. As illustrated in FIG. 2, the information processing apparatus 10 includes a communication interface 11, a memory 12, and a controller 13.

The communication interface 11 includes a communication module connected to the network 50. For example, the communication interface 11 may include a communication module compliant with mobile communication standards such as the 4G and the 5G standards. In an embodiment, the information processing apparatus 10 is connected to the network 50 via the communication interface 11. The communication interface 11 transmits and receives various information via the network 50.

The memory 12 is, for example, a semi-conductor memory, a magnetic memory, an optical memory, or the like, but is not limited to these. The memory 12 may function as, for example, a main memory, an auxiliary memory, or a cache memory. The memory 12 stores any information used in operation of the information processing apparatus 10. For example, the memory 12 may store a system program, an application program, various types of information received by the communication interface 11, and the like. Information stored in the memory 12 may be updated with, for example, information received from the network 50 via the communication interface 11.

The controller 13 includes at least one processor. The “processor” is a general purpose processor or a dedicated processor that is dedicated to specific processing in an embodiment but is not limited to these. The controller 13 is connected to each component included in the information processing apparatus 10 so as to communicate with each component, and controls operation of the entire information processing apparatus 10.

The controller 13 receives holding information on each cooking class to be held in the vehicle 40 from the second terminal apparatus 30 via the network 50 and the communication interface 11. The controller 13 receives provision information on each ingredient provider who provides an ingredient to be used in a corresponding cooking class, from each first terminal apparatus 20 via the network 50 and the communication interface 11. The controller 13 executes matching between a cooking class and an ingredient provider based on the holding information and the provision information that are received. The controller 13 determines ingredient procurement information to be notified to the ingredient provider according to the result of the matching. The controller 13 transmits the determined ingredient procurement information to the first terminal apparatus 20 of the ingredient provider related to the ingredient procurement information via the communication interface 11 and the network 50.

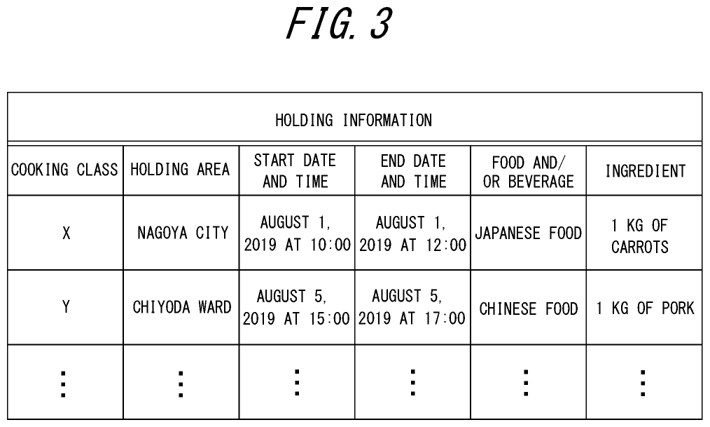

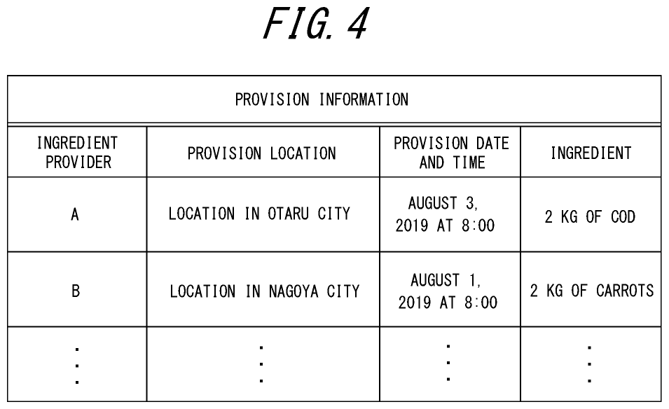

FIG. 3 is a first diagram for explaining matching between a cooking class and an ingredient provider. FIG. 4 is a second diagram for explaining the matching between the cooking class and the ingredient provider. Referring to FIGS. 3 and 4, examples of a matching process and a determining process for ingredient procurement information executed by the controller 13 will be described in more detail.

The controller 13 acquires holding information on cooking class X to be held in the vehicle 40. According to the holding information on cooking class X, the holding area is Nagoya City. Similarly, the start date and time, and the end date and time are Aug. 1, 2019 at 10:00 and 12:00, respectively, and the food and/or beverage to be the theme of cooking class X is Japanese food. An ingredient required in cooking class X in relation to the food and/or beverage is 1 kg of carrots.

The controller 13 acquires holding information on cooking class Y to be held in the vehicle 40. According to the holding information on cooking class Y, the holding area is Chiyoda Ward. Similarly, the start date and time, and the end date and time are Aug. 5, 2019 at 15:00 and 17:00, respectively, and the food and/or beverage to be the theme of cooking class Y is Chinese food. The ingredient required in cooking class Y in relation to the food and/or beverage is 1 kg of pork.

In addition to the holding information on cooking classes X and Y, the controller 13 may further acquire holding information on other cooking classes. The holding information is not limited to the contents illustrated in FIG. 3, and may include any content. For example, the number of types of ingredients required by one cooking class is not limited to one, and may be two or more.

The controller 13 acquires provision information on ingredient provider A who provides an ingredient to be used in a cooking class. According to the provision information on ingredient provider A, the provision location desired by ingredient provider A is a predetermined location in Otaru City. Similarly, the provision date and time desired by ingredient provider A is Aug. 3, 2019 at 8:00, and the ingredient is 2 kg of cod.

The controller 13 acquires provision information on ingredient provider B who provides an ingredient to be used in a cooking class. According to the provision information on ingredient provider B, the provision location desired by ingredient provider B is a predetermined location in Nagoya City. Similarly, the provision date and time desired by ingredient provider B is Aug. 1, 2019 at 8:00, and the ingredient is 2 kg of carrots.

In addition to the provision information on ingredient providers A and B, the controller 13 may further acquire provision information on other ingredient providers. The provision information is not limited to the contents illustrated in FIG. 4, and may include any content. For example, the number of types of ingredients that one ingredient provider desires to provide is not limited to one, and may be two or more.

In this situation, the holding area, the start date and time, and the ingredient for cooking class X correspond to the provision location, the provision date and time, and the ingredient for ingredient provider B, respectively. Therefore, the controller 13 extracts the holding information associated with cooking class X and the provision information associated with ingredient provider B, from the holding information on the cooking classes and the provision information on the ingredient providers that are acquired, thereby executing matching between cooking class X and ingredient provider B.

According to the result of such matching, the controller 13 may determine the procurement location regarding procurement of the ingredient to be, for example, the location in Nagoya City desired by ingredient provider B as the provision location, or the vicinity thereof. Similarly, the controller 13 may determine the procurement date and time regarding the procurement of the ingredient to be, for example Aug. 1, 2019 at 8:00, which ingredient provider B desires as the provision date and time, or the vicinity thereof. Similarly, the controller 13 may determine the ingredient regarding the procurement of the ingredient to be, for example, 1 kg of carrots, which will actually be required in cooking class X, out of 2 kg of carrots that ingredient provider B desires to provide.

The controller 13 receives participant information on participants including an instructor and a student participating in a cooking class, from the second terminal apparatus 30 via the network 50 and the communication interface 11. The controller 13 determines pickup information for the vehicle 40 to pick up the participants of the cooking class, based on the received participant information. In addition, the controller 13 determines, as procurement route information, a route for navigating the vehicle 40 to the location at which an ingredient is to be procured, the location being included in the determined ingredient procurement information. The controller 13 transmits the determined pickup information to the second terminal apparatus 30 and the vehicle 40 via the communication interface 11 and the network 50. he controller 13 transmits the determined procurement route information along with the ingredient procurement information to the vehicle 40 via the communication interface 11 and the network 50.

The controller 13 acquires evaluation information indicating a result of an evaluation by one of another from among the instructor and the student of the cooking class and an ingredient provider. For example, the controller 13 receives instructor evaluation information or student evaluation information from the first terminal apparatus 20 of the ingredient provider via the network 50 and the communication interface 11. For example, the controller 13 receives student evaluation information or ingredient provider evaluation information from a terminal apparatus used by the instructor via the second terminal apparatus 30, the network 50, and the communication interface 11. For example, the controller 13 receives instructor evaluation information or ingredient provider evaluation information from a terminal apparatus used by the student via the second terminal apparatus 30, the network 50, and the communication interface 11.

The controller 13 may determine, for example, a food and/or a beverage to be the theme of the cooking class included in the holding information, based on the acquired student evaluation information. For example, when the controller 13 determines that an evaluation rank in the acquired student evaluation information is lower than a predetermined rank, the controller 13 may determine the food and/or beverage to be the theme of the cooking class, to be a food and/or a beverage that is easier to cook. For example, when the controller 13 determines that the evaluation rank in the acquired student evaluation information is equal to or higher than the predetermined rank, the controller 13 may determine the food and/or beverage to be the theme of the cooking class, to be a food and/or a beverage that is more complicated to cook. Similarly, the controller 13 may determine the food and/or beverage to be the theme of the cooking class by associating an evaluation score, an evaluation comment, and the like in the acquired student evaluation information, with the difficulty of cooking the food and/or beverage.

The controller 13 may determine, for example, a tuition fee to be paid by the student to the operating company for taking the cooking class, based on the acquired student evaluation information. For example, when the controller 13 determines that the evaluation rank in the acquired student evaluation information is lower than a predetermined rank, the controller 13 may determine the tuition fee to be higher than a predetermined amount. For example, when the controller 13 determines that the evaluation rank in the acquired student evaluation information is equal to or higher than the predetermined rank, the controller 13 may determine the tuition fee to be equal to or lower than the predetermined amount. Similarly, the controller 13 may determine the tuition fee to be paid by the student to the operating company, by associating the evaluation score, the evaluation comment, and the like in the acquired student evaluation information, with the tuition fee.

The controller 13 may determine, for example, a payment to be obtained by the instructor from the operating company for giving the cooking instructions in the cooking class, based on the acquired instructor evaluation information. For example, when the controller 13 determines that an evaluation rank in the acquired instructor evaluation information is lower than a predetermined rank, the controller 13 may determine the payment to be lower than a predetermined amount. For example, when the controller 13 determines that the evaluation rank in the acquired instructor evaluation information is equal to or higher than the predetermined rank, the controller 13 may determine the payment to be equal to or higher than the predetermined amount. Similarly, the controller 13 may determine the payment to be obtained by the instructor from the operating company, by associating an evaluation score, an evaluation comment, and the like in the acquired instructor evaluation information, with the payment.

The controller 13 may determine, for example, a purchase fee to be paid by the operating company that operates the cooking class to the ingredient provider for the ingredient, based on the acquired ingredient provider evaluation information. For example, when the controller 13 determines that an evaluation rank in the acquired ingredient provider evaluation information is lower than a predetermined rank, the controller 13 may determine the purchase fee for the ingredient to be lower than a predetermined amount. For example, when the controller 13 determines that the evaluation rank in the acquired ingredient provider evaluation information is equal to or higher than the predetermined rank, the controller 13 may determine the purchase fee for the ingredient to be equal to or higher than the predetermined amount. Similarly, the controller 13 may determine the purchase fee for the ingredient to be paid by the operating company to the ingredient provider, by associating an evaluation score, an evaluation comment, and the like in the acquired ingredient provider evaluation information, with the purchase fee for the ingredient.

The controller 13 transmits all of the above mentioned determination information determined based on the evaluation information, to the second terminal apparatus 30 via the communication interface 11 and the network 50. In addition, the controller 13 transmits information regarding the purchase fee for the ingredient to be paid by the operating company to the ingredient provider, which is determined based on the ingredient provider evaluation information, to the first terminal apparatus 20 via the communication interface 11 and the network 50.

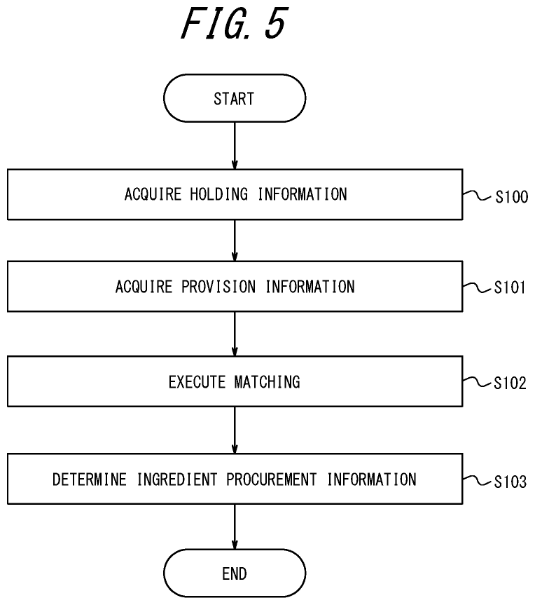

Next, an information processing method executed by the controller 13 of the information processing apparatus 10 according to an embodiment will be described, referring to FIGS. 5 to 8. FIG. 5 is a flowchart for explaining a first example of the information processing method executed by the information processing apparatus 10 in FIG. 1.

In step S100, the controller 13 acquires holding information on each cooking class to be held in the vehicle 40.

In step S101, the controller 13 acquires provision information on each ingredient provider who provides an ingredient to be used in a corresponding cooking class.

In step S102, the controller 13 executes matching between a cooking class and an ingredient provider based on the holding information acquired in step S100 and the provision information acquired in step S101.

In step S103, the controller 13 determines ingredient procurement information to be notified to the ingredient provider according to the result of the matching in step S102.

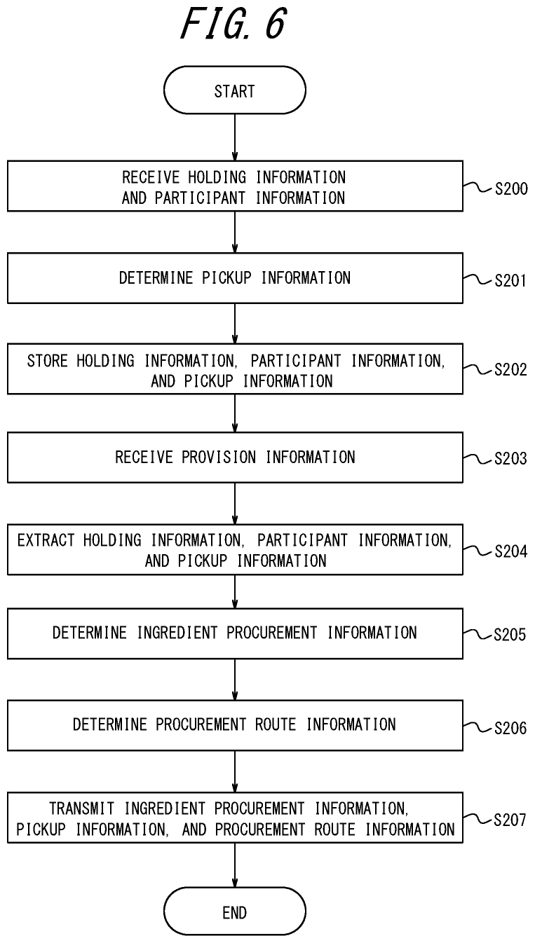

FIG. 6 is a flowchart for explaining a second example of the information processing method executed by the information processing apparatus 10 in FIG. 1. The flowchart given in FIG. 6 illustrates the control flow of the flowchart given in FIG. 5 in more detail. The flowchart in FIG. 6 illustrates a control flow performed when execution of the matching between the cooking class and the ingredient provider is triggered by transmittal of the provision information to the information processing apparatus 10 by the ingredient provider using the first terminal apparatus 20.

In step S200, the controller 13 receives the holding information on each cooking class to be held in the vehicle 40 and participant information related to the holding information, from the second terminal apparatus 30 via the network 50 and the communication interface 11.

In step S201, the controller 13 determines pickup information for the vehicle 40 to pick up participants including an instructor and a student of each cooking class, based on the participant information on the participants.

In step S202, the controller 13 stores the holding information and the participant information received in step S200 and the pickup information determined in step S201, in the memory 12.

In step S203, the controller 13 receives the provision information from the first terminal apparatus 20 of the ingredient provider via the network 50 and the communication interface 11.

In step S204, the controller 13 executes the matching by extracting a series of information including the holding information, the participant information, and the pickup information corresponding to the provision information received in step S203, from the series of information associated with the cooking classes.

In step S205, the controller 13 determines the ingredient procurement information to be notified to the ingredient provider according to the result of the matching in step S204.

In step S206, the controller 13 determines, as procurement route information, a route for navigating the vehicle 40 to the location at which the ingredient is to be procured, the location being included in the ingredient procurement information determined in step S205,

In step S207, the controller 13 transmits the ingredient procurement information determined in step S205 to the first terminal apparatus 20 and the vehicle 40 via the communication interface 11 and the network 50. The controller 13 transmits the pickup information determined in step S201 to the second terminal apparatus 30 and the vehicle 40 via the communication interface 11 and the network 50. The controller 13 transmits the procurement route information determined in step S206 to the vehicle 40 via the communication interface 11 and the network 50.

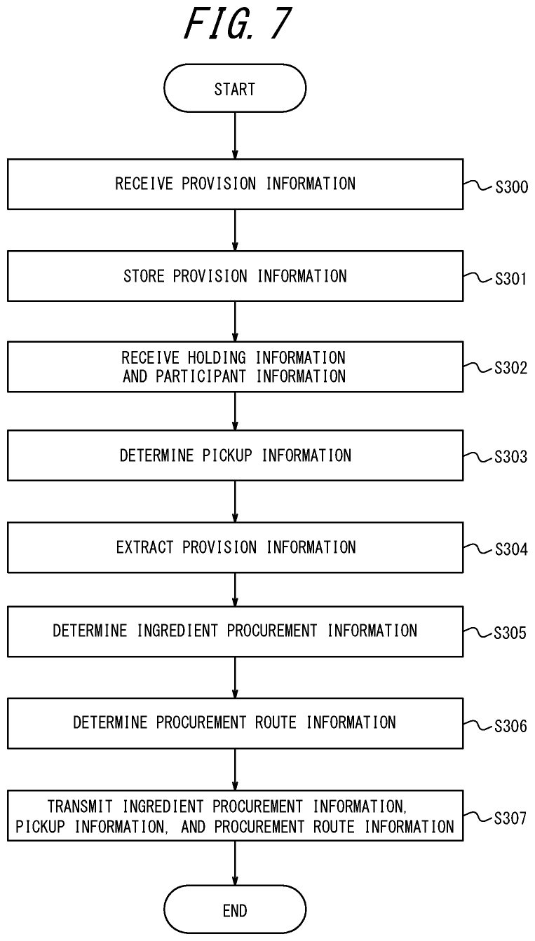

FIG. 7 is a flowchart for explaining a third example of the information processing method executed by the information processing apparatus 10 in FIG. 1. The flowchart given in FIG. 7 illustrates the control flow of the flowchart given in FIG. 5 in more detail. The flowchart in FIG. 7 illustrates a control flow performed when execution of the matching between the cooking class and the ingredient provider is triggered by transmittal of the holding information to the information processing apparatus 10 by a member of staff of an operating company that operates the cooking class using the second terminal apparatus 30

In step S300, the controller 13 receives the provision information on each ingredient provider who provides a corresponding cooking class with the ingredient, from the first terminal apparatus 20 of each ingredient provider via the network 50 and the communication interface 11.

In step S301, the controller 13 stores the provision information received in step S300 in the memory 12.

In step S302, the controller 13 receives the holding information on a cooking class to be held in the vehicle 40 and participant information related to the holding information, from the second terminal apparatus 30 via the network 50 and the communication interface 11.

In step S303, the controller 13 determines pickup information for the vehicle 40 to pick up participants including an instructor and a student of the cooking class, based on the participant information on the participants.

In step S304, the controller 13 executes the matching by extracting the provision information corresponding to the holding information and the participant information related to the holding information that are received in step S302, from the provision information associated with each ingredient provider.

In step S305, the controller 13 determines the ingredient procurement information to be notified to an ingredient provider according to the result of matching in step S304.

In step S306, the controller 13 determines, as procurement route information, a route for navigating the vehicle 40 to the location at which the ingredient is to be procured, the location being included in the ingredient procurement information determined in step S305.

In step S307, the controller 13 transmits the ingredient procurement information determined in step S305 to the first terminal apparatus 20 and the vehicle 40 via the communication interface 11 and the network 50. The controller 13 transmits the pickup information determined in the step S303 to the second terminal apparatus 30 and the vehicle 40 via the communication interface 11 and the network 50. The controller 13 transmits the procurement route information determined in step S306 to the vehicle 40 via the communication interface 11 and the network 50.

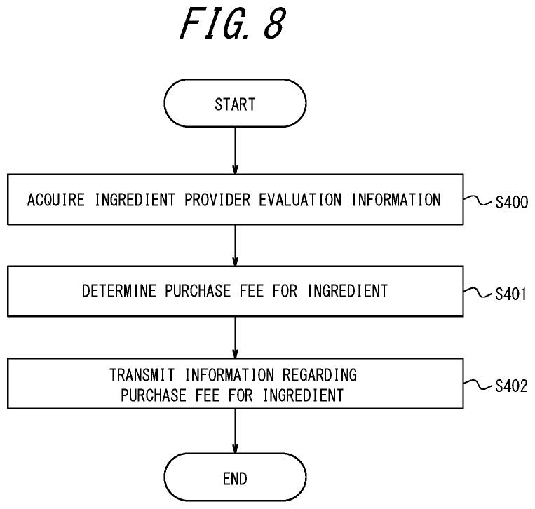

FIG. 8 is a flowchart for explaining a fourth example of the information processing method executed by the information processing apparatus 10 in FIG. 1. The flowchart given in FIG. 8 illustrates a control flow that is executed when the information processing apparatus 10 receives evaluation information indicating a result of an evaluation of the ingredient provider by the instructor or the student of the cooking class from the second terminal apparatus 30 via the network 50 and the communication interface 11, for example, after the cooking class has been held.

In step S400, the controller 13 acquires the evaluation information indicating the result of the evaluation of the ingredient provider by the instructor or the student of the cooking class.

In step S401, the controller 13 determines a purchase fee to be paid by the operating company that operates the cooking class to the ingredient provider for the ingredient based on the ingredient provider evaluation information acquired in step S400.

In step S402, the controller 13 transmits information regarding the purchase fee for the ingredient determined in step S401 to the first terminal apparatus 20 and the second terminal apparatus 30 via the communication interface 11 and the network 50. The first terminal apparatus 20 receives the information regarding the purchase fee for the ingredient from the information processing apparatus 10 via the network 50 and the communication interface 21. The second terminal apparatus 30 receives the information regarding the purchase fee for the ingredient from the information processing apparatus 10 via the network 50 and the communication interface 31.

FIG. 8 illustrates a control flow of the information processing apparatus 10 relating to the purchase fee for the ingredient in the above described determination information that is determined based on the evaluation information. A similar control flow applies to other determination information. In this case, the controller 36 of the second terminal apparatus 30 may transmit other determination information received from the information processing apparatus 10 to a terminal apparatus used by the instructor and/or a terminal apparatus used by the student, as required.

According to the above mentioned embodiment, since the vehicle 40 is used for holding a cooking class and procuring an ingredient, the procurement location and the procurement date and time at which the ingredient is to be procured can be easily adjusted depending on the moving time and the moving place of the vehicle 40. That is, the limitations on the procurement location and the procurement date and time at which the ingredient is to be procured from an ingredient provider are sufficiently relaxed, and thus the potential for matching between the cooking class and the ingredient provider is improved. As a result, the ingredient held by the ingredient provider is effectively provided to the cooking class. In this way, the service regarding the ingredient procurement and the service regarding the cooking class are successively associated, thereby increasing the certainty that a surplus of ingredients, which the ingredient provider has, will be consumed by being effectively utilized in the cooking class. Therefore, the utilization efficiency of the ingredient held by the ingredient provider is improved, and the possibility that the ingredient will be discarded wastefully is reduced.

As in the control flow illustrated in FIG. 6, the execution, by the information processing apparatus 10, of the matching between the cooking class and the ingredient provider is triggered by transmittal of the provision information to the information processing apparatus 10 by the ingredient provider using the first terminal apparatus 20, thereby selecting in real time the most appropriate cooking class in accordance with the provision information on the ingredient provider from the plurality of cooking classes stored in the information processing apparatus 10. For example, at the point when the ingredient provider falls into a state of excessively holding ingredients, the ingredient provider can search on demand for the most appropriate cooking class in accordance with the provision information. Therefore, the utilization efficiency of the ingredient held by the ingredient provider is improved. In addition, the convenience for the ingredient provider who uses the information processing system 1 which includes the information processing apparatus 10 is improved. Further, the purchase fee for the ingredient is paid by the operating company that operates the cooking class, to thereby improve the profit for the ingredient provider obtained by provision of the ingredient. By the above, satisfaction of the ingredient provider is improved, and the mechanism for providing the ingredient from the ingredient provider becomes effective.

As in the control flow of FIG. 7, the execution, by the information processing apparatus 10, of the matching between the cooking class and the ingredient provider is triggered by transmittal of the holding information to the information processing apparatus 10 by the member of staff of the operating company that operates the cooking class using the second terminal apparatus 30, thereby selecting in real time the most appropriate ingredient provider in accordance with the holding information on the cooking class from the plurality of ingredient providers stored in the information processing apparatus 10. Therefore, the convenience for the operating company that uses the information processing system 1 which includes the information processing apparatus 10 is improved. The operating company can find with more certainty an ingredient provider who is able to provide an ingredient required in a cooking class, and can run the cooking class smoothly.

By acquiring the evaluation information indicating the result of the evaluation by one of another from among the instructor and the student of the cooking class and the ingredient provider, the information processing apparatus 10 can determine various information related to the evaluation information for the instructor, the student, and the ingredient provider. Utilizing the various determined information in the service regarding the cooking class and the service regarding the procurement of the ingredient improves the attractiveness of these services. Thus, the frequency of use of these services by the instructor, the student, and the ingredient provider is increased. As a result, the profit for the operating company obtained by operation of the cooking class and the profit for the ingredient provider obtained by the provision of ingredient are improved.

The information processing apparatus 10 determines the food and/or beverage to be the theme of the cooking class included in the holding information based on the acquired student evaluation information, thereby enabling the operating company, which receives notification of the determined food and/or beverage, to hold the cooking class most appropriate for the cooking level of the student. The student who takes such a cooking class can also receive cooking instructions most appropriate for the cooking level of the student. Therefore, the attractiveness of the service regarding the cooking class is improved, and the frequency of use of the service by the student is increased.

The information processing apparatus 10 determines the tuition fee to be paid by the student to the operating company for taking the cooking class, based on the acquired student evaluation information, thereby enabling the operating company, which receives notification of the determined tuition fee, to present to the student, the tuition fee most appropriate for the cooking level of the student. The student who takes the cooking class also attempts to improve his/her cooking level in order to lower the tuition fee, and thus his/her motivation for cooking is increased. Therefore, the attractiveness of the service regarding the cooking class is improved, and the frequency of use of the service by the student is increased. In addition, the student attempts to seriously give an evaluation comment for the ingredient provider regarding the provided ingredient, in order to lower the tuition fee. Thus, the quality of the evaluation comment to be made is improved. As a result, the service regarding a series of ingredient procurement and the service regarding the cooking class become more attractive, and the frequency of use of these services by the instructor, the student, and the ingredient provider is increased.

The information processing apparatus 10 determines the payment to be obtained by the instructor from the operating company for giving the cooking instructions in the cooking class, based on the acquired instructor evaluation information, thereby enabling the operating company, which receives notification of the determined payment, to pay to the instructor, the payment most appropriate for the instruction level of the instructor. The instructor who gives the cooking instructions in the cooking class also attempts to improve his/her instruction level in order to raise the payment, and thus his/her motivation for giving the cooking instructions is increased. Therefore, the attractiveness of the service regarding the cooking class is improved, and the frequency of use of the service by the instructor is increased. In addition, the instructor attempts to seriously give an evaluation comment for the ingredient provider regarding the provided ingredient, in order to raise the payment. Thus, the quality of the evaluation comment to be made is improved. As a result, the service regarding a series of ingredient procurement and the service regarding the cooking class become more attractive, and the frequency of use of these services by the instructor, the student, and the ingredient provider is increased.

The information processing apparatus 10 determines the purchase fee to be paid by the operating company that operates the cooking class to the ingredient provider for the ingredient, based on the acquired ingredient provider evaluation information, thereby enabling the operating company, which receives notification of the determined purchase fee for the ingredient, to present to the ingredient provider, for example, the purchase fee most appropriate for the quality of the ingredient provided by the ingredient provider. The ingredient provider who provides the ingredient also attempts to provide a higher quality ingredient in order to raise the purchase fee. Thus, the quality of the ingredient to be used in the cooking class is improved. As a result, the service regarding a series of ingredient procurement and the service regarding the cooking class become more attractive, and the frequency of use of these services by the instructor, the student, and the ingredient provider is increased.

The information processing apparatus 10 determines the pickup information based on the participant information, thereby enabling the vehicle 40 to pick up the instructor and student at the most appropriate times and places via the most appropriate route, for example, with automated driving. In addition, the information processing apparatus 10 determines the route for navigating the vehicle 40 to the determined location at which the ingredient is to be procured, thereby enabling the vehicle 40 to move to the location at which the ingredient is to be procured via the most appropriate route, for example, with automated driving.

The cooking class is held in the vehicle 40, thereby ensuring the privacy of the participants participating in the cooking classes. Thus, the reticence of the participants to participate in the cooking class is reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each configuration, each step, or the like, may be rearranged without logical inconsistency, and a plurality of configurations, steps, or the like can be combined into one, or divided.

For example, in the embodiment described above, one or some processing operations executed in the information processing apparatus 10 may be executed in the first terminal apparatus 20 and/or the second terminal apparatus 30. At least one or some processing operations executed in the first terminal apparatus 20 and/or the second terminal apparatus 30 may be executed in the information processing apparatus 10.

For example, a configuration in which a general purpose electronic device such as a smartphone, a computer, or the like may be caused to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, the disclosure according to an embodiment can also be implemented as a program executable by a processor. Alternatively, the disclosure according to an embodiment can also be implemented as a non-transitory computer readable medium storing a program executable by a single processor or a plurality of processors to cause the information processing apparatus 10, the first terminal apparatus 20, or the like according to the embodiment to execute the functions. It is to be understood that these are also included within the scope of the present disclosure.

For example, in the embodiment described above, the vehicle 40 has been described as an automated driving vehicle, but is not limited thereto. The vehicle 40 may not be an automated driving vehicle. In a vehicle 40, which is not an automated driving vehicle, routes based on the pickup information and the procurement route information that are received may be output to the driver, and driving along each route may be assisted.

For example, the information processing apparatus 10 described in the above embodiment may be mounted in the vehicle 40. In this case, the information processing apparatus 10 may directly perform information communication with the vehicle 40 without using the network 50. The information processing system 1 may not include the first terminal apparatus 20 and the second terminal apparatus 30, and the information processing apparatus 10 mounted in the vehicle 40 may execute the above described acquisition and notification of the information using any input interface and output interface provided in the vehicle 40. An electronic control unit (ECU) mounted in the vehicle 40 may function as the controller 13.

For example, in the embodiment described above, the cooking class has been described as being hosted by the operating company, but is not limited thereto. The cooking class may be hosted by at least one of the participants including the instructor and the student participating in the cooking class. In this case, at least one of the participants including the instructor and the student may provide the holding information on each cooking class to be held in the vehicle 40, from a terminal apparatus used by the at least one participant to the information processing apparatus 10. That is, the second terminal apparatus 30 may be a terminal apparatus used by a participant. In this case, the second terminal apparatus 30 serving as the terminal apparatus used by the participant may acquire the address of the participant as the participant information from the input interface 33, and transmit the participant information to the information processing apparatus 10 via the communication interface 31 and the network 50. The second terminal apparatus 30 is not limited to this, and may transmit the positional information for the second terminal apparatus 30 acquired by the positional information acquisition interface 35 as the participant information to the information processing apparatus 10. The information processing apparatus 10 may determine the pickup information for the vehicle 40 to pick up the participants of the cooking class, based on the received positional information for the second terminal apparatus 30.

For example, in the embodiment described above, the first terminal apparatus 20 has been described as acquiring the provision location desired by the ingredient provider as the provision information from the input interface 23, and transmitting the provision information to the information processing apparatus 10 via the communication interface 21 and the network 50, but is not limited thereto. The first terminal apparatus 20 may transmit the positional information for the first terminal apparatus 20 acquired by the positional information acquisition interface 25 as the provision information to the information processing apparatus 10. The information processing apparatus 10 may determine the ingredient procurement information including the location at which the ingredient is to be procured, based on the received positional information for the first terminal apparatus 20.

For example, in the embodiment described above, the cooking class may be held after the information processing apparatus 10 executes the matching and the procurement of the ingredient is completed, or the information processing apparatus 10 may execute the matching in real time while the cooking class is being held, and the cooking class may be held while the ingredient is being procured.

For example, in the embodiment described above, the information processing apparatus 10 has been described as executing the matching by extracting specific holding information and specific provision information, but is not limited thereto. For example, in a case in which there is a plurality of candidate cooking classes for the matching, the information processing apparatus 10 may transmit candidate information as a list to the first terminal apparatus 20 of the ingredient provider. The ingredient provider may select the holding information on a specific cooking class which the ingredient provider ultimately desires, while checking a candidate list displayed on the output interface 24 of the first terminal apparatus 20.

For example, in the embodiment described above, the information processing apparatus 10 has been described as executing the matching by extracting specific holding information and specific provision information, but is not limited thereto. For example, in a case in which there is a plurality of candidate ingredient providers for the matching, the information processing apparatus 10 may transmit candidate information as a list to the second terminal apparatus 30. The member of staff of the operating company may select the provision information on a specific ingredient provider whom the member of staff ultimately desires, while checking a candidate list displayed on the output interface 34 of the second terminal apparatus 30. Similarly, the instructor or the student of the cooking class may select the provision information on a specific ingredient provider whom the instructor or the student ultimately desires, based on the candidate information transmitted from the second terminal apparatus 30 to his/her terminal apparatus.

1. An information processing apparatus comprising a controller configured to:
acquire holding information on a cooking class to be held in a vehicle and provision information on an ingredient provider who provides an ingredient to be used in the cooking class;
execute matching between the cooking class and the ingredient provider based on the holding information and the provision information that are acquired; and
determine ingredient procurement information to be notified to the ingredient provider according to a result of the matching.

2. The information processing apparatus according to claim 1, wherein, upon receiving the provision information from a first terminal apparatus of the ingredient provider, the controller executes the matching by extracting the holding information corresponding to the received provision information, and transmits the determined ingredient procurement information to the first terminal apparatus.

3. The information processing apparatus according to claim 1, wherein, upon receiving the holding information from a second terminal apparatus which is separate from a first terminal apparatus of the ingredient provider, the controller executes the matching by extracting the provision information corresponding to the received holding information, and transmits the determined ingredient procurement information to the first terminal apparatus.

4. The information processing apparatus according to claim 1, wherein the controller is configured to acquire evaluation information indicating a result of an evaluation by one of another from among an instructor and a student of the cooking class and the ingredient provider.

5. The information processing apparatus according to claim 4, wherein
the evaluation information indicates a result of an evaluation of the ingredient provider by the instructor or the student, and the controller is configured to determine a purchase fee for the ingredient, based on the acquired evaluation information for the ingredient provider.

6. The information processing apparatus according to claim 1, wherein the controller is configured to determine pickup information for the vehicle to pick up participants including an instructor and a student of the cooking class, based on participant information on the participants, and to determine a route for navigating the vehicle to a location at which the ingredient is to be procured, the location being included in the determined ingredient procurement information.

7. A vehicle equipped with the information processing apparatus according to claim 1.

8. An information processing system comprising:
the information processing apparatus according to claim 1;
a first terminal apparatus of the ingredient provider, the first terminal apparatus being configured to transmit the provision information to the information processing apparatus; and
a second terminal apparatus which is separate from the first terminal apparatus of the ingredient provider, the second terminal apparatus being configured to transmit the holding information to the information processing apparatus.

9. A non-transitory computer readable medium storing a program executable by one or more processors to cause an information processing apparatus to execute functions, the functions comprising:
acquiring holding information on a cooking class to be held in a vehicle;
acquiring provision information on an ingredient provider who provides an ingredient to be used in the cooking class;
executing matching between the cooking class and the ingredient provider based on the holding information and the provision information that are acquired; and
determining ingredient procurement information to be notified to the ingredient provider according to a result of the matching.

10. The non-transitory computer readable medium according to claim 9, wherein the acquiring of the provision information comprises receiving the provision information from a first terminal apparatus of the ingredient provider, and the executing of the matching comprises executing the matching by extracting the holding information corresponding to the received provision information,
the functions further comprising transmitting the ingredient procurement information determined by the determining of the ingredient procurement information, to the first terminal apparatus.

11. The non-transitory computer readable medium according to claim 9, wherein the acquiring of the holding information comprises receiving the holding information from a second terminal apparatus which is separate from a first terminal apparatus of the ingredient provider, and the executing of the matching comprises executing the matching by extracting the provision information corresponding to the received holding information,
the functions further comprising transmitting the ingredient procurement information determined by the determining of the ingredient procurement information, to the first terminal apparatus.

12. The non-transitory computer readable medium according to claim 9, the functions further comprising acquiring evaluation information indicating a result of an evaluation by one of another from among an instructor and a student of the cooking class and the ingredient provider.

13. The non-transitory computer readable medium according to claim 12, wherein the evaluation information indicates a result of an evaluation of the ingredient provider by the instructor or the student,
the functions further comprising determining a purchase fee for the ingredient, based on the evaluation information for the ingredient provider acquired by the acquiring of the evaluation information.

14. The non-transitory computer readable medium according to claim 9, the functions further comprising:
determining pickup information for the vehicle to pick up participants including an instructor and a student of the cooking class, based on participant information on the participants; and
determining a route for navigating the vehicle to a location at which the ingredient is to be procured, the location being included in the ingredient procurement information determined by the determining of the ingredient procurement information.

15. A non-transitory computer readable medium storing a program executable by one or more processors to cause a terminal apparatus of an ingredient provider who provides an ingredient to be used in a cooking class, to execute functions, the functions comprising:
transmitting provision information on the ingredient provider who provides the cooking class to be held in a vehicle with the ingredient, to an information processing apparatus; and
receiving ingredient procurement information determined by the information processing apparatus according to a result of matching between the cooking class and the ingredient provider executed by the information processing apparatus based on holding information on the cooking class and the provision information that are acquired by the information processing apparatus.

16. The non-transitory computer readable medium according to claim 15, wherein, when the provision information transmitted by the transmitting of the provision information is received by the information processing apparatus, the holding information corresponding to the received provision information is extracted by the information processing apparatus to thereby execute the matching, and the ingredient procurement information determined by the information processing apparatus is received by the receiving of the ingredient procurement information.

17. The non-transitory computer readable medium according to claim 15, wherein, when the holding information is received by the information processing apparatus from a terminal apparatus which is separate from the terminal apparatus of the ingredient provider, the provision information corresponding to the received holding information is extracted by the information processing apparatus to thereby execute the matching, and the ingredient procurement information determined by the information processing apparatus is received by the receiving of the ingredient procurement information.

18. The non-transitory computer readable medium according to claim 15, the functions further comprising receiving evaluation information acquired by the information processing apparatus, the evaluation information indicating a result of an evaluation of the ingredient provider by an instructor or a student of the cooking class.

19. The non-transitory computer readable medium according to claim 18, the functions further comprising receiving information regarding a purchase fee for the ingredient that is determined by the information processing apparatus based on the acquired evaluation information for the ingredient provider.

20. The non-transitory computer readable medium according to claim 15, wherein the ingredient procurement information includes a location at which the ingredient is to be procured, the location being located on a route for navigating the vehicle and being determined by the information processing apparatus.
